(19) United States
(12) Patent Application Publication
(10) Pub. No.: US 2023/0014399 A1
(43) Pub. Date: Jan. 19, 2023

(54) Model Training Utilizing Parallel Execution of Containers

(71) Applicant: SAP SE, Walldorf (DE)

(72) Inventors: Subhadeep Khan, Bangalore (IN); Darko Velkoski, Berlin (MK); Vipul Prabhu, Bangalore (IN)

(21) Appl. No.: 17/375,390

(22) Filed: Jul. 14, 2021

(51) Int. Cl. G06N 20/20; G06F 9/48; G06F 9/455; G06T 1/20

(52) U.S. Cl. CPC G06N 20/20; G06F 9/4887; G06F 9/45558; G06T 1/20; G06F 2009/4557

(57) ABSTRACT

Embodiments relate to systems and methods that create a final model by parallel training of models executed within separate containers. A master job present within one container, performs pre-processing (e.g., noise reduction; duplicate removal) of incoming data. The master job orchestrates the training of individual models by child jobs that are executed in parallel within respective separate containers. After checking the status of completion of the child jobs (e.g., via HTTP or by reading local progress files) the master job references the trained models in order to determine a final model. This final model determination may comprise aggregating the trained models, or selecting one model based upon a metric (such as a f1 score). Parallel training of models by child jobs executed within separate containers, streamlines and accelerates model creation. Particular embodiments may be suited to train a model that identifies unique entities from incoming data including names and addresses.

### BACKGROUND

Unless otherwise indicated herein, the approaches described in this section are not prior art to the claims in this application and are not admitted to be prior art by inclusion in this section.

Machine learning is assuming an increasingly important role in data processing. For a sophisticated learning procedure, it may be desired to train multiple models with different configurations. However, such model training efforts can be consumptive of available processing and memory resources.

### SUMMARY

Embodiments relate to systems and methods that create a final model by parallel training of models executed within separate containers. A master job present within one container, performs pre-processing (e.g., noise reduction; duplicate removal) of incoming data. The master job orchestrates the training of individual models by child jobs that are executed in parallel within respective separate containers. After checking the status of completion of the child jobs (e.g., via HTTP or by reading local progress files) the master job references the trained models in order to determine a final model. This final model determination may comprise aggregating the trained models, or selecting one model based upon a metric (such as a f1 score). Parallel training of models by child jobs executed within separate containers—e.g., Graphics Processor Unit (GPU) based containers—serves to streamline and accelerate model creation. Particular embodiments may be suited to train a model that identifies unique entities from incoming data including names and addresses.

The following detailed description and accompanying drawings provide a better understanding of the nature and advantages of various embodiments.

### BRIEF DESCRIPTION OF THE DRAWINGS

FIG. 1 shows a simplified diagram of a system according to an embodiment.

FIG. 2 shows a simplified flow diagram of a method according to an embodiment.

FIG. 3 shows a simplified block diagram illustrating the relationship between a master job and child jobs according to an exemplary embodiment.

FIG. 4 shows values indicating the progress of model training conducted in series.

FIG. 5 shows values indicating the progress of model training conducted in parallel.

FIGS. 6A-B show an example of a central progress file.

FIG. 7 shows storage of child job details in a file of a folder.

FIG. 8 shows an exemplary file structure.

FIGS. 9-11 show examples of pseudocode.

FIG. 12 is a table showing experimental results.

FIG. 13 illustrates hardware of a special purpose computing machine configured to implement model training according to an embodiment.

FIG. 14 illustrates an example computer system.

### DETAILED DESCRIPTION

Described herein are methods and apparatuses that model training. In the following description, for purposes of explanation, numerous examples and specific details are set forth in order to provide a thorough understanding of embodiments according to the present invention. It will be evident, however, to one skilled in the art that embodiments as defined by the claims may include some or all of the features in these examples alone or in combination with other features described below, and may further include modifications and equivalents of the features and concepts described herein.

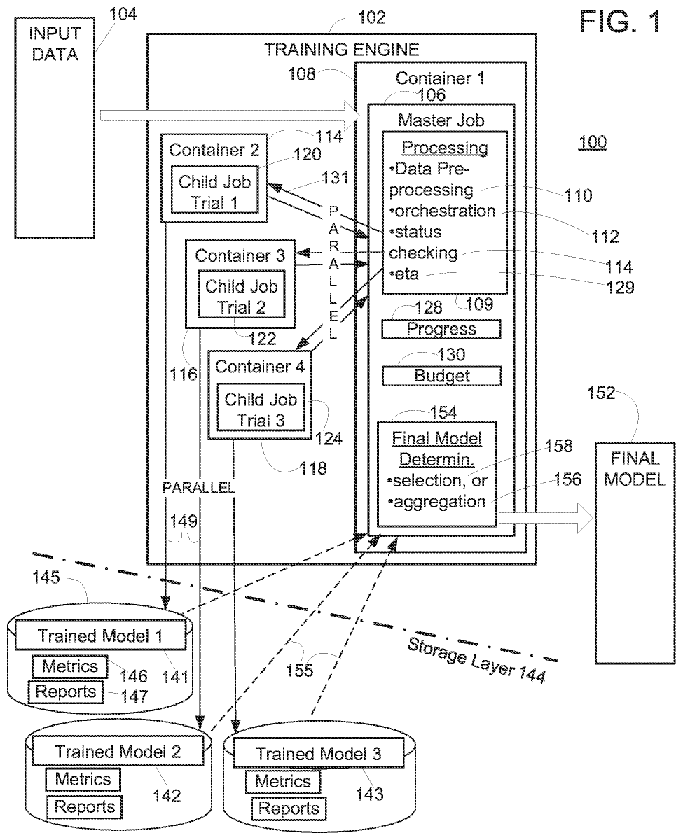

FIG. 1 shows a simplified view of an example system that is configured to implement model training according to an embodiment. Specifically, system 100 comprises a processing engine 102 that is configured to receive input data 104 for use in training a final model 152.

In order to do this, the training engine first creates a master job 106 that is executed within a first container 108. Examples of containers can include, but are not limited to: Graphic Processing Units (GPUs) or Virtual Machines (VMs).

The master job is responsible for performing a variety of processing 109 activities. For example, the processing by the master job may include pre-processing 110 of the incoming data. Such data pre-processing can comprise noise reduction and/or the removal of duplicate entries.

The processing by the master job also includes orchestration 112 of the training of models amongst separate containers. In particular, individual containers 114, 116, and 118 are created to host the execution of child jobs 120, 122, and 124 respectively. Owing to the computational intensity of training complex models, these individual containers for the child jobs may be GPU-based.

These child jobs run in parallel to train the discrete models according to the incoming data. Such parallel execution of child jobs serves to streamline and accelerate model training, as compared with sequential model training approaches.

The processing by the master job further includes checking 126 (e.g., by polling), the status of training of the various models that is taking place within the different containers.

The model training statuses may be recorded in a progress file 128.

In certain embodiments, communication 131 between the master job and child jobs may take place via HTTP. In some embodiments, the master job may detect model training status by reading a local progress file of a child job.

The checking may further result in the master job:
calculating an estimated time of arrival (eta) 129 for the conclusion of training of the models; and/or
comparing model training times with a predetermined (e.g., time) budget 130.

As they are being created and trained in parallel by the child jobs, the models 141, 142, and 143 are stored 149 within storage layer 144 in database(s) 145. Also stored within the database(s) are corresponding metrics 146 (e.g., f1 value) and reports 147 for the models.

Lastly, once the individual models have been trained by the child jobs, a final model 152 is determined 154 from them. In particular, the master job references 155 the trained models within the storage layer.

Under some circumstances, the final model may be determined by the master job aggregating 156 two or more of the models.

Under other circumstances, the final model determination may be as simple as selecting 158 one of the models as the final model. Such selection could be based, e.g., upon a comparison of metrics (such as f1 scores) between the various trained models.

Once determined, the final model is ready for use in its designated task. For example, as described in detail later below, one such task may be to accurately identify discrete entities (e.g., individual persons, unique business entities) from a large volume of available incoming data (e.g., first names, family names, formal names, nicknames, corporate names, street addresses, cities, states, nations, etc.).

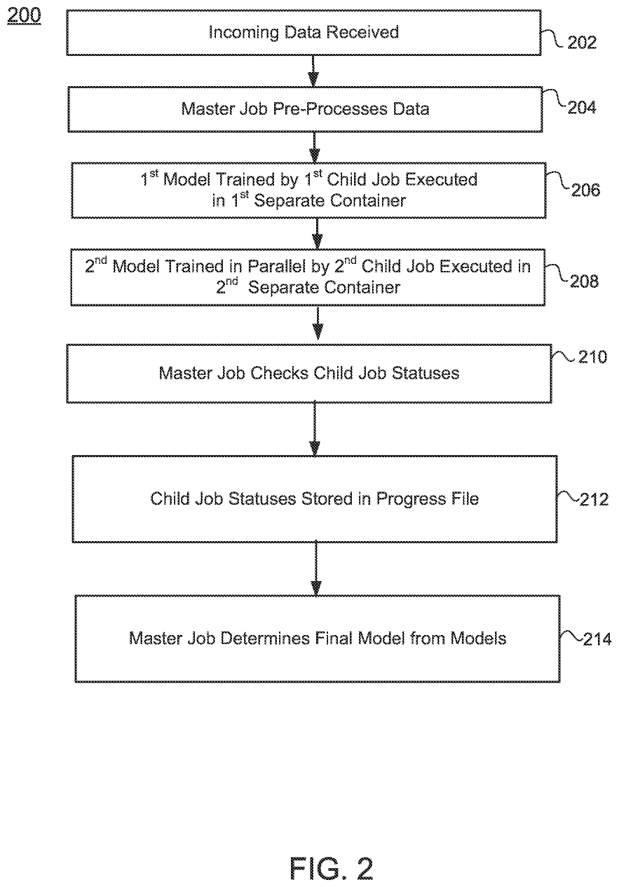

FIG. 2 is a flow diagram of a method 200 according to an embodiment. At 202, incoming data is received. At 204, the incoming data is pre-processed by a master job executed within a first container.

At 206, a first model is trained with preprocessed data by a first child job executed within a second container. At 208, in parallel with the training of the first model, a second model is trained with preprocessed data by a second child job executed within a third container.

At 210, the master job checks a status of the first child job and a status of the second child job. At 212 the master job stores the status of the first child job and the status of the second child job, within a progress file.

At 214, the master job determines a final model from the first model and from the second model.

Systems and methods according to embodiments, may avoid one or more issues that may be associated with model training. In particular, embodiments allow parallel training of models in order to conserve potentially scarce resources such as processing power, bandwidth, memory capacity, and/or time budget.

Further details regarding model training according to various embodiments, are now provided in connection with the following example.

### EXAMPLE

A system according to this exemplary embodiment is configured to train models that are used in entity recognition. Specifically, entity recognition can play an important part in data processing.

For example, a same entity may exhibit different variants of identifying data, such as address (including global addresses), name, and formal legal structure. Accordingly, there is a need for rapid and accurate recognition of entities based upon known data.

In this example, trainings for each of the models are independent to each other in nature, and can run in isolation. Hence trainings of all the different models (with different configurations) are run in multiple containers in parallel.

Accordingly, the overall model training time can be reduced. And, based on the same upper limit on training time, more models can be trained thereby improving the overall accuracy as well.

Details regarding training parallelization using multiple containers according to this exemplary embodiment, are now described. In particular, the overall model training process can be divided into three main phases.

A first phase is data preprocessing. Here, the incoming data is read and transformed. Data statistics and/or other information helpful for model training, are extracted.

A second phase is training the models. Here, the trainings for all of the models occurs. This phase is the major contributor to the overall training time.

A third phase is computing the final model. This can be as simple as selecting the best model based on metrics (such as f1 score). Alternatively, the final model may be computed by aggregating multiple models.

Conventionally, a single training procedure runs as a job in one Docker container using GPU. However, in a training parallelization approach according to this exemplary embodiment, two types of jobs are defined.

A first job type is a master job. When a training job is created by an end user, a first container is provided. This is the master job.

Responsibilities of the master job can include but are not limited to:
performing the data preprocessing,
extracting data statistics
determining the number of trials; and
creating separate child jobs to run individual trials in separate docker container.

Each child job trains a model—e.g., a computationally intensive Deep Neural Network (DNN) model. Hence, for child jobs a Graphics Processor Unit (GPU) based container may be provided for each child job.

Then, the master job polls the child jobs. Once the child jobs are complete, the master job aggregates the sub models to produce the final model. There will be only one master job for training.

A second job type is a child job. Based on the number of trials, the master job creates the child jobs.

Each child job execution runs in a separate docker container and is responsible for the training of a particular model. There will be as many jobs as the number of recommended trials.

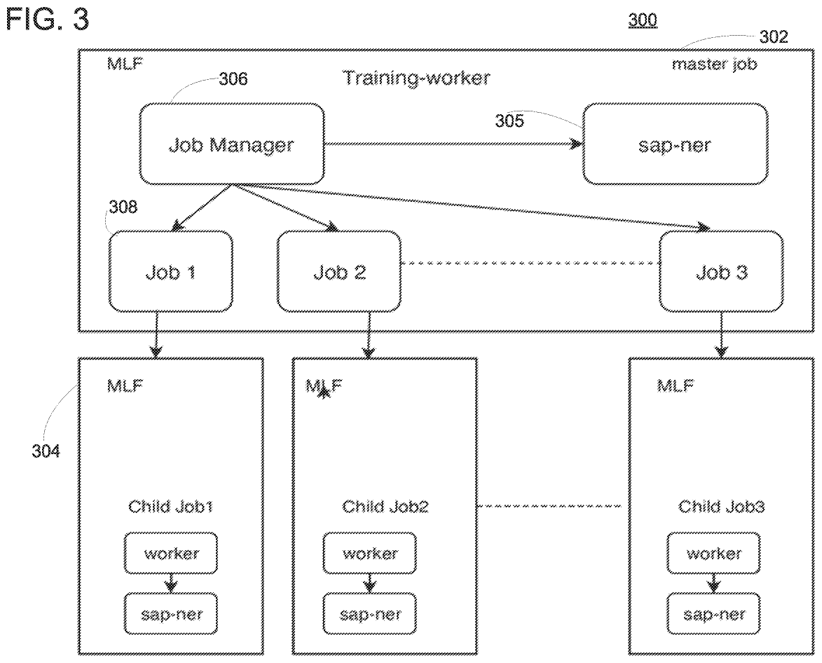

Further details regarding implementation of entity recognition according to this exemplary embodiment, are now provided. In particular, FIG. 3 shows a simplified block diagram illustrating the relationship 300 between the master job 302 and child jobs 304 according to an exemplary embodiment. The term sap-ner 305 refers to general software that is utilized for machine learning training of models (whether performed in series, or in parallel as in the instant exemplary embodiment).

Creation of a master job is now described. Whenever a user triggers a training, the training worker create a master job which runs in a single Docker container. The job status of the master job is accessible by using the job polling API.

As the input data is shared by the trials, computation of the data statistics, language detection, and other data preprocessing (e.g., duplicate removal, noise detection, others) are executed in the master job. There is no need to replicate these in each of the child jobs responsible for running the specific trials.

For creation and orchestration of child jobs, a job manager class 306 shall be created for parallel job executions for running multiple trials in separate docker container. This job manager will be responsible for the orchestration of child jobs, whereas the Job class 308 will be created to do the job specific handling and submitting the particular jobs.

The master job will create an instance of the job manager and create the trial specific child jobs. Separate child jobs will be created for each trial determined by the overall training strategy.

Each child job will run then in separate Docker container provided by the KUBERNETES cluster. Whenever the trial corresponding to a configuration is completed in the child job, the job status will be written in a file: <job_id>_job_status.txt.

The job manager will poll the jobs using job status API at a certain interval. If a particular job status is not available in the response or the job is completed, the job manager will get the status from the job status file. The access token for accessing the API will be stored and reused for all the API calls until it gets expired.

For aggregation of the child job results, once the child jobs are completed or discarded, the master job should be ready to do the model aggregation and finding the best model. Each of the child job creates the model artifacts, classification reports, and model evaluation metrics in storage layer.

The child job writes the job status details in the storage once the job gets completed. The master job reads the job status, classification from the storage to decide on final models.

Progress updating and calculation of estimated time of arrival (eta) is now described. As the overall model training takes some time, it may be convenient for the user to provide some ongoing progress and estimated completion time.

When trials run sequentially:

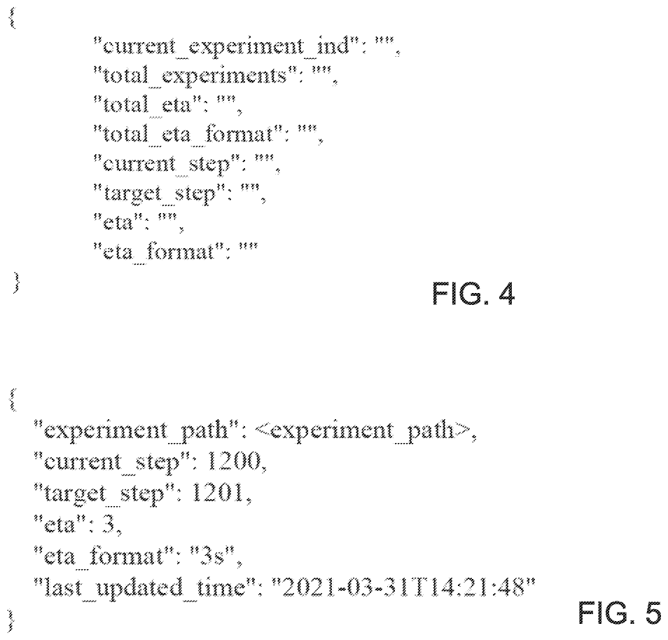

current_experiment_ind,
total_experiments,
current_step, and
total_steps
give the indication for the progress of the total training, as shown in FIG. 4.

However, in the training parallelization approach according to embodiments, trials are run at the same time in separate containers. Thus trial progress needs to be updated at every interval by the child job.

Hence there should be multiple progress files:

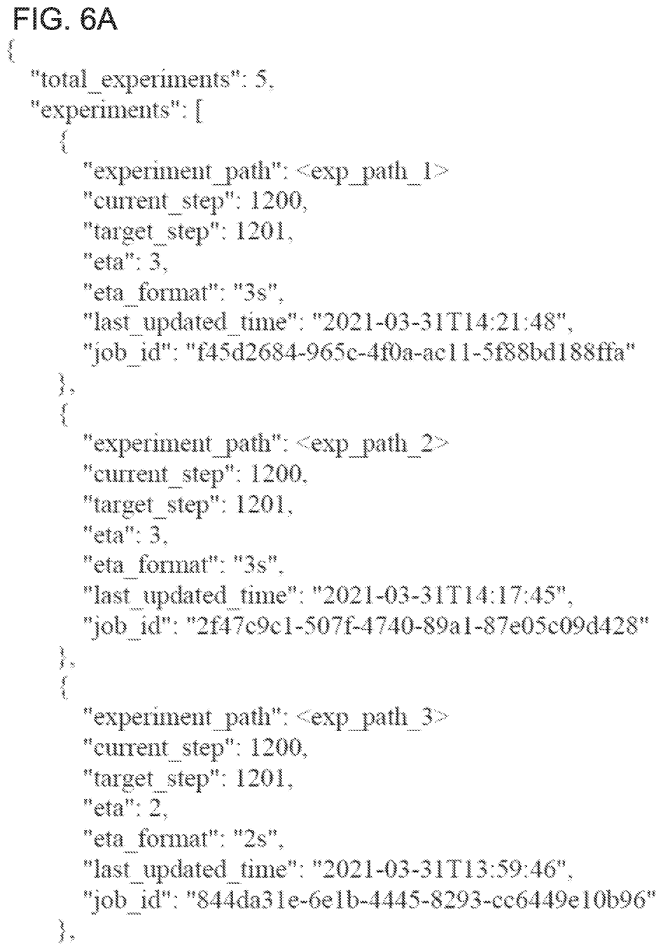

(<experiment.job_id>_progress.json), each for the child job. This is shown in FIG. 5.

It is still needed to give the overall training progress information to the user. Thus a central progress information mechanism is employed.

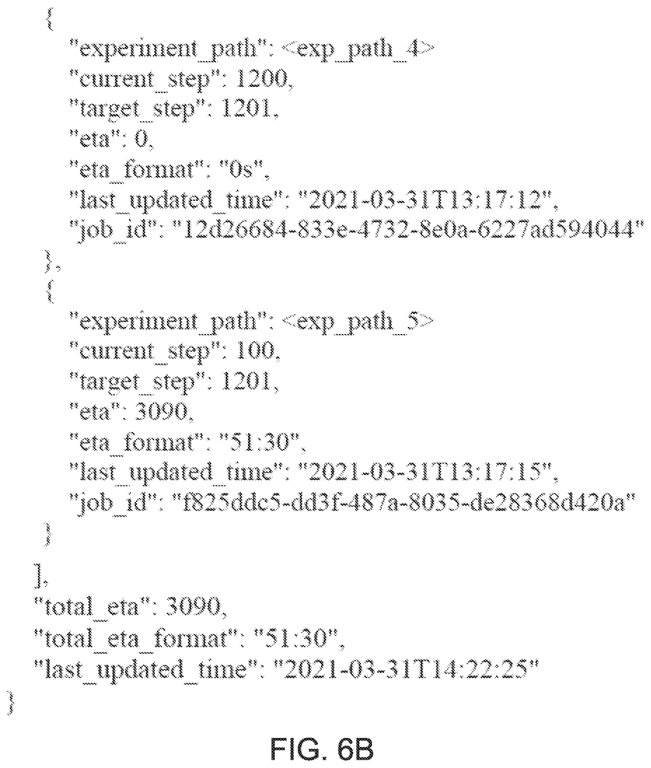

The master job is responsible for creating and maintaining the central progress file (progress.json), as shown in FIGS. 6A-B. The master job reads the progress files for all the child jobs and creates the central progress information by combining the results.

It may not be straightforward to give the eta when the trials run in parallel. Due to resource unavailability, all of the child jobs may not be picked up at the same time and may get delayed.

Owing to these factors, there may be different scenarios for the child jobs. One scenario is that all of the jobs are pending. Here, as no jobs are running, we are unaware of the eta of the trials. Hence, the time budget (configurable) is used to compute the eta:

eta=(budget−time_elapsed_after_job_submission).

According to another scenario, a few of the jobs are pending, a few of them are running, and a few of them are completed. In this scenario eta is computed as follows:

eta=max(eta_i−current_timestamp+last_updated_timestamp_i, (budget −time_elapsed_after_job_submission)).
Here, eta_i is the eta of running trial i, and last_updated timestamp_i=eta updated time for the running trial i.

According to still another possible scenario, all of the jobs are running or completed. Then eta may be calculated as follows:

total_eta=max(eta_i−current_timestamp+last_updated_timestamp_i).
Again in this scenario, eta_i is the eta of running trial i; last_updated timestamp_i=eta updated time for the running trial i.

Budget compliance according to the exemplary embodiment is now discussed. The budget parameter is used to define the upper limit for the overall training time.

When all the trials run sequentially, if the time exceeds the budget before starting any trial, all the remaining trials are discarded. However, when the trials run in parallel and the time exceeds the defined budget, all the ‘RUNNING’ experiments are waited to be finished. Then all the ‘PENDING’ or ‘RUNNING’ jobs are deleted.

Partial failure handling according to the exemplary embodiment, is now discussed. When a particular child job fails, it is ignored and the master job execution is continued with the other trials. Also, the failed trials shall be ignored in determining the final model.

Communication between the master job and child jobs according to the exemplary embodiment, is now discussed. As the master job and child jobs run in separate containers, some way of communicating between them is needed.

In general there are two types of communication we use between master job and child jobs. A first type of communication is HTTP communication. There, the master job uses the REST API to poll the status of the child jobs.

A second type of communication between the master and child jobs may occur via storage. There, each child job has its own progress file in storage to avoid the race condition.

A progress thread is run in the child job container to update the job specific progress. The master job only reads the child job specific progress files and creates a central progress file.

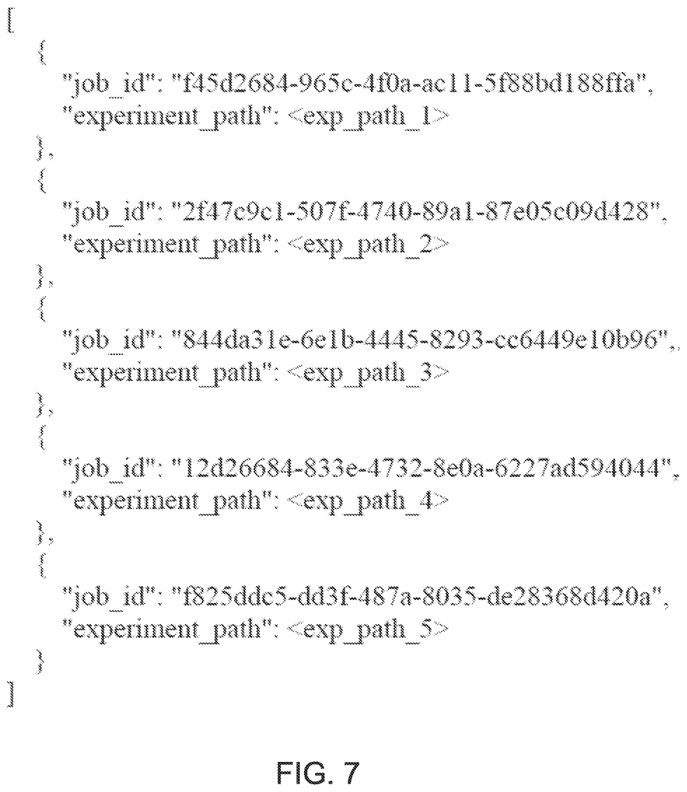

Storing job details according to the exemplary embodiment is now described. The child job details shall be stored in a file experiment_jobs.txt under the /training/<job_id>folder, as shown in FIG. 7.

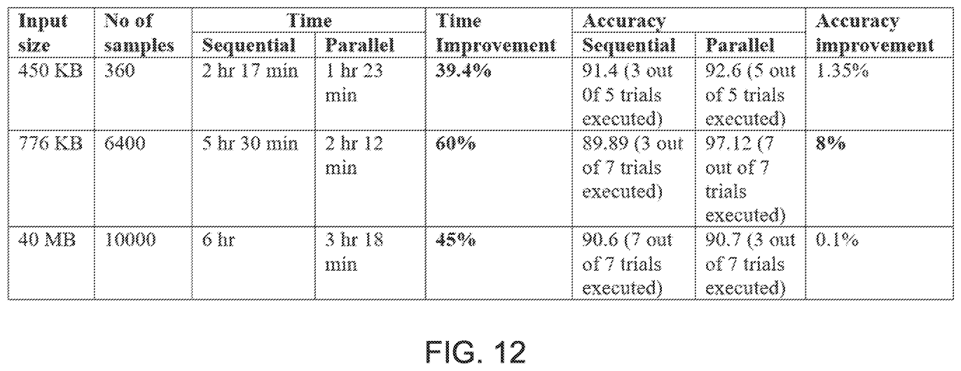

When the trials run sequentially, the logs are written in file training.dog in the training directory. But, when the trials run in parallel the logs for individual trials are written in separate files in order to avoid the race condition. The experimental results of FIG. 12 discussed later below, contrast the difference between trials run sequentially and in parallel.

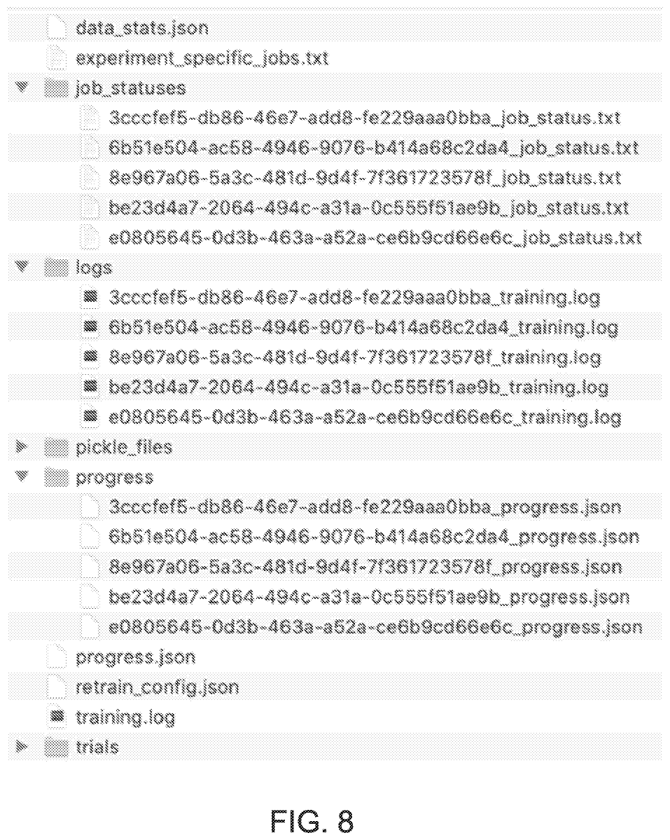

Along with the log file, the job specific status and progress may also be written in separate files. FIG. 8 is an exemplary file structure showing how the master job and child status, logs, and progress may be stored.

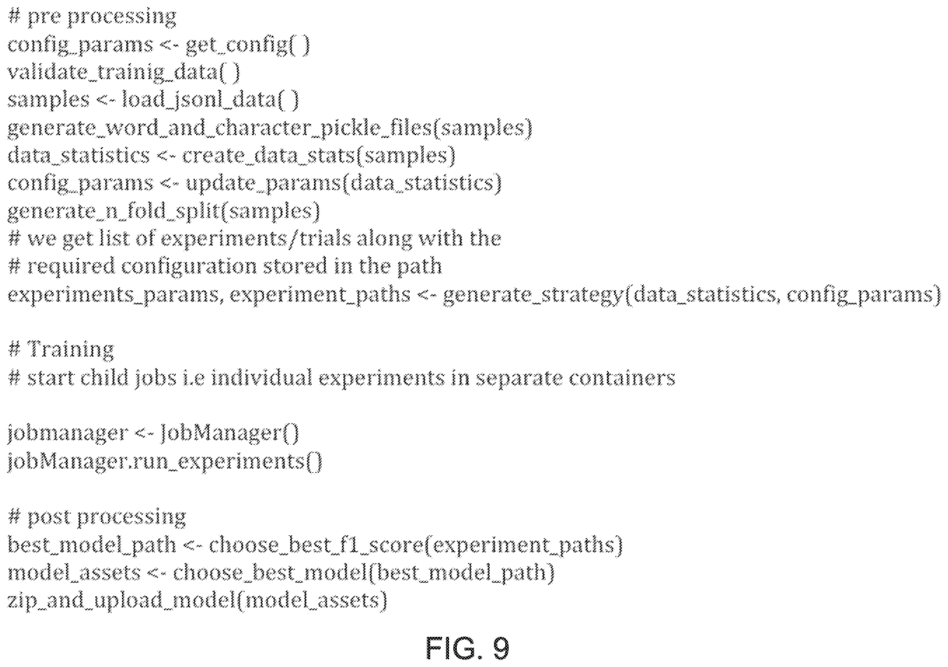

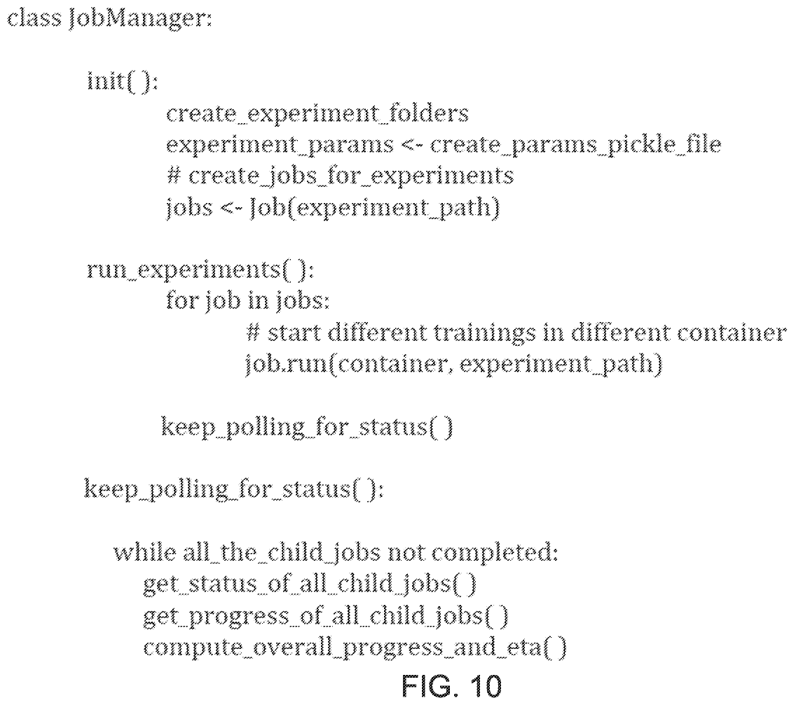

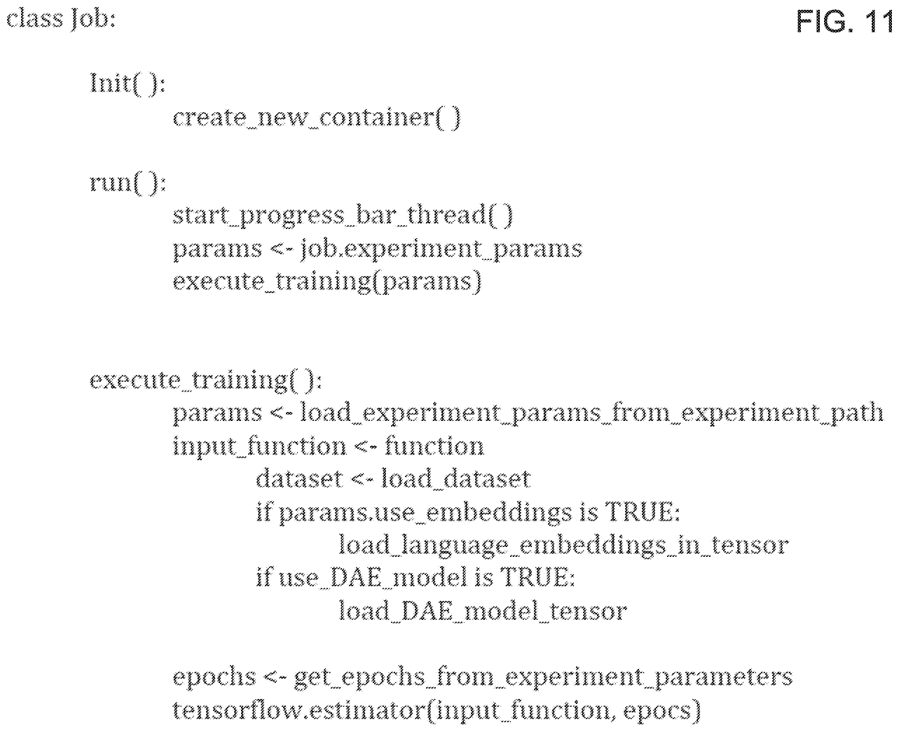

Examples of pseudocode for various elements discussed above, are now provided. In particular, pseudocode for train.py is shown in FIG. 9. Pseudocode for job_manager.py is shown in FIG. 10. Pseudocode for job.py is shown in FIG. 11.

Results of entity recognition performed according to the exemplary embodiment are shown in the table of FIG. 12. From these results, the time improvement can be observed for all the experiments.

Also, it is observed that for the sequential approach, the first and second experiments could not run completely due to time budget. By contrast, for the parallelization approach the first and second experiments could be run completely.

Regarding accuracy, FIG. 12 shows no degradation for the parallel approach. In the first and third experiments, optimal accuracy was achieved in the first three trials.

In the second experiment, the optimal accuracy was achieved for the 5th trial. Along with the time improvement, an improvement in accuracy was observed.

Returning now to FIG. 1, there the particular embodiment is depicted with the engine responsible for model training as being located outside of the data stores. However, this is not required.

Rather, alternative embodiments could leverage the processing power of an in-memory database engine (e.g., the in-memory database engine of the HANA in-memory database available from SAP SE), in order to perform various functions as described above.

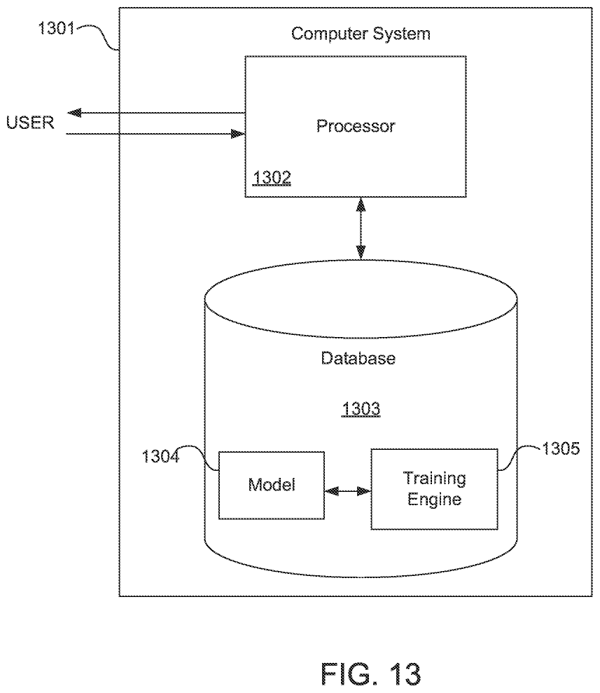

Thus FIG. 13 illustrates hardware of a special purpose computing machine configured to implement model training according to an embodiment. In particular, computer system 1301 comprises a processor 1302 that is in electronic communication with a non-transitory computer-readable storage medium comprising a database 1303. This computer-readable storage medium has stored thereon code 1305 corresponding to a training engine. Code 1304 corresponds to a model. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

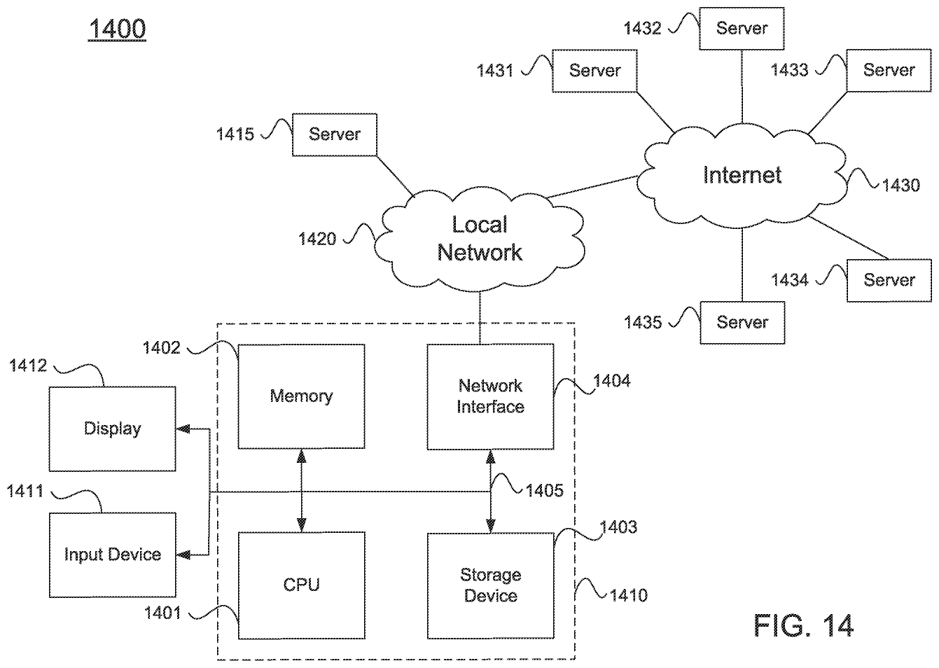

An example computer system 1400 is illustrated in FIG. 14. Computer system 1410 includes a bus 1405 or other communication mechanism for communicating information, and a processor 1401 coupled with bus 1405 for processing information. Computer system 1410 also includes a memory 1402 coupled to bus 1405 for storing information and instructions to be executed by processor 1401, including information and instructions for performing the techniques described above, for example. This memory may also be used for storing variables or other intermediate information during execution of instructions to be executed by processor 1401. Possible implementations of this memory may be, but are not limited to, random access memory (RAM), read only memory (ROM), or both. A storage device 1403 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 1403 may include source code, binary code, or software files for performing the techniques above, for example. Storage device and memory are both examples of computer readable mediums.

Computer system 1410 may be coupled via bus 1405 to a display 1412, such as a Light Emitting Diode (LED) or liquid crystal display (LCD), for displaying information to a computer user. An input device 1411 such as a keyboard and/or mouse is coupled to bus 1405 for communicating information and command selections from the user to processor 1401. The combination of these components allows the user to communicate with the system. In some systems, bus 1405 may be divided into multiple specialized buses.

Computer system 1410 also includes a network interface 1404 coupled with bus 1405. Network interface 1404 may provide two-way data communication between computer system 1410 and the local network 1420. The network interface 1404 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 1404 sends and receives electrical, electromagnetic, or optical signals that carry digital data streams representing various types of information.

Computer system 1410 can send and receive information, including messages or other interface actions, through the network interface 1404 across a local network 1420, an Intranet, or the Internet 1430. For a local network, computer system 1410 may communicate with a plurality of other computer machines, such as server 1415. Accordingly, computer system 1410 and server computer systems represented by server 1415 may form a cloud computing network, which may be programmed with processes described herein. In the Internet example, software components or services may reside on multiple different computer systems 1410 or servers 1431-1435 across the network. The processes described above may be implemented on one or more servers, for example. A server 1431 may transmit actions or messages from one component, through Internet 1430, local network 1420, and network interface 1404 to a component on computer system 1410. The software components and processes described above may be implemented on any computer system and send and/or receive information across a network, for example.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1. Computer implemented system and methods comprising:

receiving incoming data;
pre-processing the incoming data by a master job executed within a first container; training a first model with preprocessed data by a first child job executed within a second container;
storing the first model together with a metric in a database;
in parallel with the training of the first model, training a second model with preprocessed data by a second child job executed within a third container;
the master job checking a status of the first child job and a status of the second child job; and
the master job storing the status of the first child job and the status of the second child job, within a progress file.

Example 2. The computer implemented system and method of Example 1 further comprising:

the master job determining a final model from the first model and from the second model.

Example 3. The computer implemented system and method of Example 2 wherein the determining comprises selecting the first model as the final model based upon a metric of the first model.

Example 4. The computer implemented system and method of Example 2 wherein the determining comprises aggregating the first model and the second model to form the final model.

Example 5. The computer implemented system and method of Example 1, 2, 3, or 4 wherein the second container is a Graphics Processing Unit (GPU) based container.

Example 6. The computer implemented system and method of Example 1, 2, 3, 4, or 5 wherein the master job checks the status of the first child job and the status of the second child job via HTTP.

Example 7. The computer implemented system and method of Example 1, 2, 3, 4, or 5 wherein the master job checks the status of the first child job and the status of the second child job by reading local progress files of the child jobs.

Example 8. The computer implemented system and method of Example 1, 2, 3, 4, 5, 6, or 7 further comprising the master job calculating an estimated time of arrival (eta) from the status of the first child job and the status of the second child job.

Example 9. The computer implemented system and method of Example 1, 2, 3, 4, 5, 6, 7, or 8 wherein the database comprises an in-memory database and the pre-processing is performed by an in-memory database engine of the in-memory database.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method comprising:
receiving incoming data;
pre-processing the incoming data by a master job executed within a first container,
training a first model with preprocessed data by a first child job executed within a second container,
storing the first model together with a metric in a database;
in parallel with the training of the first model, training a second model with preprocessed data by a second child job executed within a third container;
the master job checking a status of the first child job and a status of the second child job; and
the master job storing the status of the first child job and the status of the second child job, within a progress file.

2. A method as in claim 1 wherein the second container is a Graphics Processing Unit (GPU) based container.

3. A method as in claim 1 wherein the master job checks the status of the first child job and the status of the second child job via HTTP.

4. A method as in claim 1 wherein the master job checks the status of the first child job and the status of the second child job by reading local progress files of the child jobs.

5. A method as in claim 1 further comprising:
the master job determining a final model from the first model and from the second model.

6. A method as in claim 5 wherein the determining comprises selecting the first model as the final model based upon a metric of the first model.

7. A method as in claim 6 wherein the metric comprises a f1 score.

8. A method as in claim 5 wherein the determining comprises aggregating the first model and the second model to form the final model.

9. A method as in claim 1 further comprising:
the master job calculating an estimated time of arrival (eta) from the status of the first child job and the status of the second child job.

10. A method as in claim 1 wherein the database comprises an in-memory database and the pre-processing is performed by an in-memory database engine of the in-memory database.

11. A non-transitory computer readable storage medium embodying a computer program for performing a method, said method comprising:
receiving incoming data;
pre-processing the incoming data by a master job executed within a first container,
training a first model with preprocessed data by a first child job executed within a second container;
storing the first model together with a metric in a database;
in parallel with the training of the first model, training a second model with preprocessed data by a second child job executed within a third container;
the master job checking a status of the first child job and a status of the second child job;
the master job storing the status of the first child job and the status of the second child job, within a progress file; and
the master job determining a final model from the first model and from the second model.

12. A non-transitory computer readable storage medium as in claim 11 wherein the master job checks the status of the first child job and the status of the second child job:
via HTTP; or
by reading local progress files of the child jobs.

13. A non-transitory computer readable storage medium as in claim 11 wherein the master job calculates an estimated time of arrival (eta) from the status of the first child job and the status of the second child job.

14. A non-transitory computer readable storage medium as in claim 11 wherein determining the final model comprises one of:
selecting the first sub model as the final model based upon a metric of the first model; and
aggregating the first model and the second model to form the final model.

15. A computer system comprising:
one or more processors;
a software program, executable on said computer system, the software program configured to cause an in-memory database engine of an in-memory database to:
receive incoming data;
pre-process the incoming data by a master job executed within a first container:
train a first model with preprocessed data by a first child job executed within a second container;
store the first model together with a metric in the in-memory database;
in parallel with training of the first model, train a second model with preprocessed data by a second child job executed within a third container;
check, by the master job, a status of the first child job and a status of the second child job; and
store, by the master job, the status of the first child job and the status of the second child job, within a progress file.

16. A computer system as in claim 15 wherein the first container comprises a Graphics Processor Unit (GPU) based container or a Virtual Machine (VM).

17. A computer system as in claim 15 wherein the master job checks the status of the first child job and the status of the second child job:
via HTTP; or
by reading local progress files of the child jobs.

18. A computer system as in claim 15 wherein the in-memory database engine is further configured to have the master job calculate an estimated time of arrival (eta) from the status of the first child job and the status of the second child job.

19. A computer system as in claim 18 wherein the in-memory database engine is further configured to compare the eta to a budget.

20. A computer system as in claim 15 wherein the in-memory database engine is further configured to determine a final model by:
selecting the first model as the final model based upon a metric of the first model; and
aggregating the first model and the second model to form the final model.
